(19) United States
(12) Patent Application Publication
(10) Pub. No.: US 2006/0203743 A1
(43) Pub. Date: Sep. 14, 2006

(54) Apparatus and methods for dynamically configurable wireless network

(76) Inventors: Liam B. Quinn, Austin, TX (US); Pratik M. Mehta, Austin, TX (US); Alan E. Sicher, Austin, TX (US)

Correspondence Address: O'KEEFE, EGAN & PETERMAN, 1101 CAPITAL OF TEXAS HIGHWAY SOUTH, #C200, AUSTIN, TX, 78746, US

(21) Appl. No.: 11/076,690

(22) Filed: Mar. 10, 2005

(51) Int. Cl. H04L 12/28; H04Q 7/00

(52) U.S. Cl. 370/254; 370/329

(57) ABSTRACT

An information handling system includes a plurality of access points, a radio network manager, and a database. The access points couple to form a wireless network. Each access point communicates with at least one mobile client. The radio network manager couples to the access points. The radio network manager is configured to dynamically control the operation of the access points. The database couples to the radio network manager and stores information about the wireless network.

### TECHNICAL FIELD

The inventive concepts relate generally to information handling apparatus and systems. More particularly, the invention concerns apparatus and associated methods for dynamically or automatically configurable wireless networks.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In one type of networking system, wireless local area network (WLAN), currently no well-defined methodology or set of metrics for WLAN deployment exists. For example, determining the optimum position to place each WLAN access point (AP) and designating the channel allocation often entails trial and error. Furthermore, beyond the initial deployment, designing the network for longer-term changes the network environment and shorter-term changes in traffic patterns typically entails changes in channel allocations, hardware additions or changes, and the like. A need exists for a network-based solution that allows dynamic tuning of the WLAN radio network to meet and adapt to varying network environments and patterns, such as traffic patterns and interference.

### SUMMARY

The disclosed novel concepts relate to apparatus for dynamically configurable wireless networks, and methods relating to dynamic configuration of wireless networks. In one embodiment, an information handling system that includes a plurality of wireless access points, a radio network manager, and a database. The access points are coupled in a wireless network. Each access point is configured to communicate with at least one mobile client. The radio network manager couples to the plurality of access points. The radio network manager is configured to dynamically control the plurality of access points. The database couples to the radio network manager, and is configured to store information about the wireless network.

Another embodiment relates to a method of dynamically configuring an operation of a wireless network. The wireless network includes a plurality of access points, each in wireless communication with at least one client. The method includes obtaining information about communication between each access point, and its respective client(s), and obtaining information about operating characteristics of the access points. The method further includes calculating parameters relating to operation of the wireless network, and using the calculated parameters to tune the wireless network.

### BRIEF DESCRIPTION OF THE DRAWINGS

The appended drawings illustrate only exemplary embodiments of the invention and therefore should not be considered or construed as limiting its scope. Persons of ordinary skill in the art who have the benefit of the description of the invention appreciate that the disclosed inventive concepts lend themselves to other equally effective embodiments. In the drawings, the same numeral designators used in more than one drawing denote the same, similar, or equivalent functionality, components, or blocks.

FIG. 1 shows an information handling system according to an exemplary embodiment of the invention.

FIG. 2 illustrates an information handling system according to another exemplary embodiment of the invention.

FIG. 3 depicts a process flow diagram for network model processing in an exemplary embodiment according to the invention.

FIG. 4 shows a process flow diagram for network measurement manipulation according to an exemplary embodiment of the invention.

FIG. 5 illustrates a block diagram for obtaining WLAN tuning parameters according to an exemplary embodiment of the invention.

### DETAILED DESCRIPTION

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

The inventive concepts disclosed here contemplate information handling systems including dynamically configurable (or reconfigurable) WLAN and associated methods. In response to a variety of parameters, such as the network environment and operating conditions, the inventive concepts provide WLAN capable of automatic configuration. The automatic or dynamic configuration of the disclosed WLANs overcome the disadvantages of conventional WLAN, such as changes made to the network because of short-term and long-term variations in the network's environment and operating conditions.

In a generic sense, information handling systems including the automatically configurable WLANS include the following components: a WLAN architecture, WLAN system based measurement and reporting mechanisms, mobile client based measurement and reporting mechanisms, a network model or map, measurement processing and analysis, and dynamic capacity and coverage overbuild and control. The following description provides details of each component. Note, however, that the embodiments shown and used to describe the inventive concepts merely constitute illustrative embodiments. One may therefore use a variety of other network architectures and dynamic configuration schemes according to the invention, as desired, and as persons of ordinary skill in the art who have the benefit of the description of the invention understand.

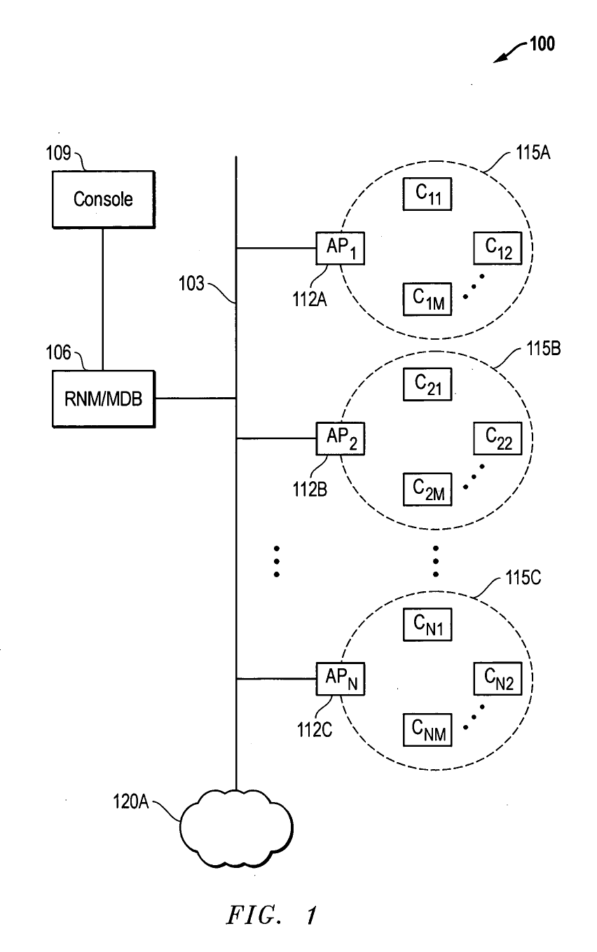

FIG. 1 shows an information handling system 100 according to an exemplary embodiment of the invention. System 100 includes a WLAN with measurement and reporting mechanisms, measurement processing and analysis using a model of the network, and dynamic capacity overbuild and control. More specifically, system 100 includes a communication medium 103 (network backbone) that facilitates communication among various system components.

Other system components include one or more (generally N) of access points (APs) 112A-112C, a radio network manager (RNM) 106 and associated console 109 and measurement database (MDB) 106. RNM/MDB 106 may constitute a variety of apparatus with processing and storage capability, such as a workstation, server, personal computer, and the like, as desired. Console 109 provides a mechanism for administering and communicating with RNM/MDB 106 (e.g., obtaining reports, status, changing various parameters, etc.), as persons of ordinary skill in the art who have the benefit of the description of the invention understand.

The specific embodiment in FIG. 1 shows the radio network manager and the measurement database as a combined unit. One may implement the radio network manager and the measurement database as separate components, distributed components, and the like. The choice of implementation depends on various factors, such as design and performance specifications for a particular WLAN, as persons of ordinary skill in the art who have the benefit of the description of the invention understand.

Each of access points 112A-112C operates in a respective one of cells 115A-115C that constitute the WLAN. Within each of cells 115A-115C, the respective access point communicates with one or more (generally M) wireless clients. For example, access point 112A communicates with clients C₁₁, C₁₂, . . . , C_{1M}, and so on. Access point 112C thus communicates with clients C_{N1}, C_{N2}, . . . , C_{NM}. In addition to the inventive functionality and circuitry described here, access points 112A-112C and clients C₁₁-C_{NM} operate in a manner known to persons of ordinary skill in the art who have the benefit of the description of the invention.

Through communication medium 103, access points 112A-112C couple to, and communicate with, RNM/MDB 106. Furthermore, communication medium 103 provides a mechanism for the WLAN (including its various components, such as access points 112A-112C, RNM/MDB 106, etc.) to communicate with an external infrastructure 120A. Infrastructure 120A may constitute a wide variety of information handling apparatus and media, as persons of ordinary skill in the art who have the benefit of the description of the invention understand. Examples include a local area network (LAN), wide-area network (WAN), stand-alone computer systems, networked resources, etc.

Note that the connections among the various components in FIG. 1 can take advantage of existing or standard interfaces (e.g., Simple Network Management Protocol, or SNMP) by extending the interfaces to provide the data exchange contemplated by the invention. APs 112A-112C may constitute existing access points, with additional functionality, processing, and interface capabilities implemented in software or firmware. Alternatively, one may use access points designed specifically for operation in the embodiments according to the invention from both a hardware and software standpoints, as desired.

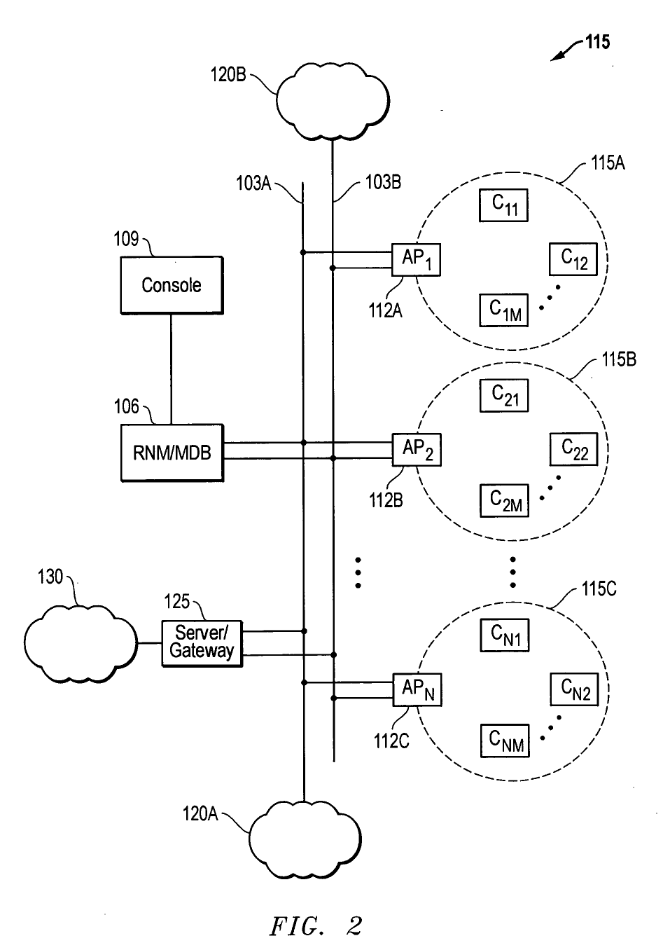

FIG. 2 shows an information handling system 115 according to another exemplary embodiment of the invention. System 115 includes components similar to those in system 100 (see FIG. 100). System 115, however, includes two communication media or backbones: communication medium 103A, and communication medium 103B. Through communication media 103A-103B, system 115 provides an additional degree of flexibility by making available a virtual LAN (VLAN) capability.

More specifically, sever/gateway 125, APs 112A-112C, and RNM/MDB 106 couple to both communication medium 103A and communication medium 103B. Communication medium 103A couples to infrastructure 120A, whereas communication medium 103B couples to infrastructure 120B. By using two communication media, system 115 provides a mechanism for coupling to two infrastructures (120A, 120B), thus increasing the flexibility and connectivity of the system. Furthermore, one may form infrastructure 120A and infrastructure 120B as a VLAN, as desired, further increasing the system's utility and flexibility.

In either system 100 or system 115 (or a variety of other possible embodiments according to the invention), APs 112A-112C compile and report in real-time (or non-real-time, for example, according to a desired schedule) various information about the WLAN to RNM/MDB 106. The information include, but are not limited to, the following items:
The number of clients for each AP (e.g., number of clients attached/associated, departed, or failed);
The aggregate client radio signal profile (e.g., the average received relative signal strength indicator, or RSSI) on the clients, its standard deviation, etc.);
Signal quality relative and interference level (e.g., S/N and/or C/I);
The aggregate AP bi-directional traffic (e.g., the number of bytes offered and carried);
User profiles and identities (e.g., authorized, unauthorized);
The bit error rate (BER) and aggregate packet loss profiles (e.g., percent packet loss and re-transmits);
The aggregate station attachment/session duration (duration of the clients' attachments to the respective APs);
Antenna signal balance information (e.g., average signal difference between two or more AP antennas); and
Mobility characteristics of users (obtainable through a variety of means known to persons of ordinary skill in the art who have the benefit of the description of the invention) to determine capacity dynamics and plan neighbor cell borders/transitions.

As noted above, the reporting may use any desired interface or protocol. For example, the reporting may use a new interface or an extended or modified interface, such as extended SNMP. As persons of ordinary skill in the art who have the benefit of the description of the invention understand, however, one may use a variety of interfaces and protocols, as desired, depending on the particular details of a given implementation.

Furthermore, each client for a particular one of APs 112A-112C provides to the respective AP client-based information relating to the WLAN. The client may use a client-initiated measurement reporting message to provide the information to the respective AP. Each client provides information including, but not limited to, the following items:
The current radio signal strength measurement for the respective AP;
The radio signal strength measurement for adjacent AP(s) (each client may periodically measure the radio signal strength of other APs during idle periods);
BER and received packet loss (e.g., percentage of packets lost); and
Positional information (e.g., position information/coordinates obtained through Global Positioning Satellites, or GPS, triangularization, and/or profiling techniques).

Upon receipts of the information from the client(s), the respective AP provides the information to RNM/MDB 106 for aggregation and/or further processing. APs 112A-112C may provide the information directly, or aggregate or process the information before sending it to RNM/MDB 106, as desired. As noted above, the reporting may use any desired interface or protocol (e.g., new, extended).

As noted, the inventive WLANs include a network model or map. RNM/MDB 106 maintains the network model. More particularly, the RNM maintains the network model in the MDB. The network model describes various characteristics of the WLAN, such as the relative placement of APs 112A-112C and their respective operating frequencies, AP power levels, and the like.

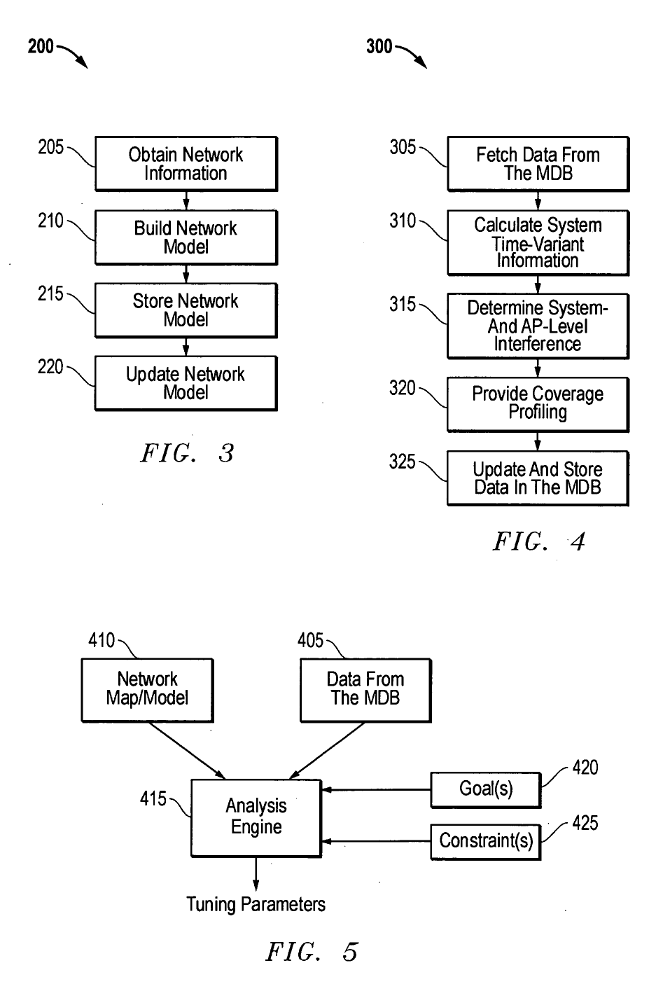

FIG. 3 shows a process flow diagram 200 for network model processing in an exemplary embodiment according to the invention. At 205, the RNM obtains information about the WLAN (for example, from the designer or architect of the WLAN). The information includes items such as the number of APs 112A-112C, the number of clients for each respective AP, etc.

At 210, the RNM builds a network model. The network model takes into account information about the network, described above. At 215, the RNM stores the network model in the MDB. At 220, the RNM updates the network model in the MDB depending on changes in the characteristics of the network and various items of information about the network (e.g., number of APs and their respective client(s), frequencies of operation, etc.).

The RNM manipulates the measurement data in the MDB. FIG. 4 shows a process flow diagram 300 for network measurement manipulation according to an exemplary embodiment of the invention. At 305, the RNM fetches network information from the MDB. At 310, the RNM calculates system time-variant information. The time-variant information may include time-variant traffic densities and congestion information (e.g., monthly, weekly, daily, and hourly trends per each of APs 112A-112C).

At 315, the RNM determines system-level and AP-level interference. The RNM makes the determination based on bi-directional signal measurements, adjacent AP signal measurements, packet loss information, and the like, as desired. At 320, the RNM calculate cell coverage profiling. The RNM makes the calculation based on path loss balance information, antenna balance information, and the system-level and AP-level interference information (described above), as desired. At 325, the RNM updates and stores the WLAN information stored in the MDB based on the results of the calculations and updates the information, as appropriate. Note that the RNM may also employ various well-known path loss and theoretical propagation models, together with measured data, to determine hypothetical coverage and signal conditions prior to making a change/update, as desired.

The RNM analyzes the processed measurements and the network map or model to determine WLAN tuning (or re-tuning) or configuration (or reconfiguration) parameters. The RNM uses those parameters to control the details of operation of each AP (e.g., its frequencies of operation, its output power level, and the like). The RNM may use an iterative rule-based optimization technique, such as integer or linear programming), as desired.

FIG. 5 shows a block diagram for obtaining WLAN tuning parameters according to an exemplary embodiment of the invention. As noted, the RNM uses network model/map 410 and MDB data 405 to perform analysis aimed at tuning or re-tuning the WLAN. More specifically, the RNM uses analysis engine 415 to process the network model 410 and MDB data 405. Analysis engine 415 receives as its inputs one or more goals 420, and one or more constraints 425. Analysis engine 415 uses a desired technique (e.g., integer or linear programming) to provide the tuning or re-tuning parameters for the WLAN. As noted, the RNM uses the tuning or re-tuning parameters to control the APs and, hence, configure or reconfigure the WLAN in a dynamic manner.

As an example, goals 420 may include maximization of the average AP bi-directional throughput, maximization of the radio signal strength, and maximization of the traffic loading for APs 112A-112C. Constraints 425 may include packet loss less than K₁ for APᵢ, path loss balance for APᵢ less than K₂, and APᵢ congestion less than K₃, where APᵢ denotes the ith AP, and K₁-K₃ denote constants; and quality of service (QoS) and predicted latency/jitter, as desired.

Analysis engine 415 seeks to optimize the WLAN tuning or re-tuning parameters based on goals 420 and constraints 425. Note that one may apply the goals and constraints on a per-AP basis or on a network-wide basis, as desired. Note further that the example given above denotes merely an illustrative set of goals 420 and constraints 425. One may use a wide variety of other goals and constraints, as desired, and as persons of ordinary skill in the art who have the benefit of the description of the invention understand.

As noted above, one aspect of the inventive concepts relates to dynamic capacity overbuild and control. More specifically, WLANs according to the invention allow for AP overbuild capacity. The marginal cost of providing an additional AP in a WLAN is relatively modest. Furthermore, because of APs' relatively low cost and their ease of connection and deployment in a LAN environment, one may provide additional APs throughout the WLAN with relative ease.

Furthermore, one may control when to turn on and activate a particular AP based on various network characteristics, such time-variant localized traffic (e.g., in a conference room), station/AP frequencies and interference, and the like. The RNM may automatically deactivate unneeded APs (for example, after a meeting in the conference room as ended) and, thus, reduce system-level interference. As noted, one may also create a VLAN within the WLAN based on parameters such as user profile, access lists, user authorization, workgroup association, and the like, as desired.

Referring to the figures, persons of ordinary skill in the art will note that the various blocks shown may depict mainly the conceptual functions and signal flow. The actual circuit implementation may or may not contain separately identifiable hardware for the various functional blocks and may or may not use the particular circuitry shown. For example, one may combine the functionality of various blocks into one circuit block, as desired. Furthermore, one may realize the functionality of a single block in several circuit blocks, as desired. The choice of circuit implementation depends on various factors, such as particular design and performance specifications for a given implementation, as persons of ordinary skill in the art who have the benefit of the description of the invention understand. Other modifications and alternative embodiments of the invention in addition to those described here will be apparent to persons of ordinary skill in the art who have the benefit of the description of the invention. Accordingly, this description teaches those skilled in the art the manner of carrying out the invention and are to be construed as illustrative only.

The forms of the invention shown and described should be taken as the presently preferred or illustrative embodiments. Persons skilled in the art may make various changes in the shape, size and arrangement of parts without departing from the scope of the invention described in this document. For example, persons skilled in the art may substitute equivalent elements for the elements illustrated and described here. Moreover, persons skilled in the art who have the benefit of this description of the invention may use certain features of the invention independently of the use of other features, without departing from the scope of the invention.

1. An information handling system, comprising:
a plurality of wireless access points coupled in a wireless network, each access point in the plurality of access points configured to communicate with at least one respective mobile client;
a radio network manager coupled to the plurality of access points, the radio network manager configured to dynamically control the plurality of access points; and
a database coupled to the radio network manager, the database configured to store information about the wireless network.

2. The information handling system according to claim 1, wherein the at least one mobile client provides a first set of information items about a communication link between the at least one mobile client and the respective access point in the plurality of access points.

3. The information handling system according to claim 2, wherein each access point in the plurality of access points provides to the radio network manager a second set of information items about communication between the access point and the respective at least one client.

4. The information handling system according to claim 3, wherein each access point in the plurality of access points provides the first set of information items to the radio network manager.

5. The information handling system according to claim 4, wherein the radio network manager calculates network tuning parameters based on the first and second sets of information items.

6. The information handling system according to claim 5, wherein the radio network manager further uses a network model stored in the measurement database to calculate network tuning parameters.

7. The information handling system according to claim 5, wherein the radio network manager uses the network tuning parameters to control the plurality of access points.

8. The information handling system according to claim 1, further comprising a virtual local area network coupled to the plurality of access points.

9. The information handling system according to claim 1, wherein a set of access points in the plurality of access points provide dynamic capacity and coverage overbuild and control within the information handling system.

10. The information handling system according to claim 1, wherein the radio network manager and the database reside within a computer.

11. The information handling system according to claim 1, wherein the radio network manager controls the plurality of access points so as to optimize an operation of the wireless network.

12. A method of dynamically configuring an operation of a wireless network, the wireless network including a plurality of access points each in wireless communication with at least one client, the method comprising:
obtaining information about communication between each access point in the plurality of access points and the respective at least one client;
obtaining information about operating characteristics of the plurality of access points;
calculating parameters relating to operation of the wireless network; and
using the calculated parameters to tune the wireless network.

13. The method according to claim 12, wherein calculating parameters relating to operation of the wireless network further comprises using a model of the wireless network, the model configured to include information about the wireless network.

14. The method according to claim 13, wherein the model of the wireless network is obtained by: (a) obtaining information about the wireless network, (b) building the model of the wireless network, (c) storing the model of the wireless network, and (d) updating the model of the wireless network.

15. The method according to claim 12, further comprising:
fetching information stored in a database that includes information about the wireless network;
calculating time-variant information about the wireless network;
determining a level of interference in the wireless network;
providing coverage profiling of the wireless network;
updating the information stored in the database.

16. The method according to claim 13, wherein calculating parameters relating to operation of the wireless network further comprises analyzing the model of the wireless network, information about communication between each access point in the plurality of access points and the respective at least one client, and information about operating characteristics of the plurality of access points.

17. The method according to claim 15 wherein analyzing the model of the wireless network, information about communication between each access point in the plurality of access points and the respective at least one client, and information about operating characteristics of the plurality of access points further comprises using an iterative optimization technique.

18. The method according to claim 16, wherein using the iterative optimization technique further comprises optimizing for at least one goal, given at least one constraint.

19. The method according to claim 17, wherein using the iterative optimization technique further comprises using linear programming or integer programming.

20. The method according to claim 12, wherein using the calculated parameters to tune the wireless network further comprises controlling an operation of the plurality of access points.
